(19) United States
(12) Patent Application Publication
(10) Pub. No.: US 2004/0249698 A1
(43) Pub. Date: Dec. 9, 2004

(54) Commodity sales number forecasting system and method, computer program product and storage medium

(76) Inventors: Yuji Kouno, Ichikawa-shi (JP); Shigehisa Okada, Aichi-ken (JP); Katsuhiko Suzuki, Nagoya-shi (JP); Youjirou Suzuki, Tokyo-to (JP)

Correspondence Address: IBM Corporation Dept. IQ0A/Blg.40-3, 1701 North Street, Endicott, NY, 13760, US

(21) Appl. No.: 10/802,459

(22) Filed: Mar. 17, 2004

Related U.S. Application Data
(63) Continuation of application No. PCT/JP02/09616, filed on Sep. 19, 2002.

(30) Foreign Application Priority Data
Sep. 20, 2001 (JP) 2001-287883

(51) Int. Cl. G06F 17/60

(52) U.S. Cl. 705/10

(57) ABSTRACT

An area sales number forecasting section calculates a forecast sales number for each commodity in each TV area that is a unit district for making a sales promotion at the same time through a spot CM of a television. And on the basis of the calculated forecast sales number for each commodity in a TV area, a shop sales number forecasting section calculates the forecast sales number for each commodity at each shop within the TV area. Thereby, the commodity sales number can be forecast by reflecting the regional characteristics of the commodity purchasing trend or the sales promotion with the television.

### FIELD OF THE INVENTION

The present invention relates to a commodity sales number forecasting system and method of calculating the forecast sales number of a commodity at each shop when selling the same commodity at a plurality of shops, a computer program useful for this calculation, and a storage medium storing the computer program.

### BACKGROUND ART

As well known, a supply chain is required to supply a commodity to be sold or its raw material to each shop efficiently, and therefore is demanded to forecast the commodity sales number at each shop precisely.

Conventionally, forecasting the commodity sales number is usually made at each shop independently, and each shop makes ordering of the commodity or the raw material on the basis of the forecast commodity sales number, while a supplier of the commodity or the raw material makes the procurement of commodity or raw material in accordance with an ordered situation from each shop.

However, there are the following problems in making the ordering operation based on the forecast commodity sales number at each shop.

(1) The operation load becomes excessive because the ordering operation is made independently at each shop.

(2) Each shop is not provided with information regarding the forecast value of raw material associated with the forecast demand or procurement in the supplier of commodity, and largely relies on the experience or perception in making the ordering, with less ordering precision.

(3) There are some inconveniences including a change immediately before delivery or an excessive inventory or shortage of commodity at the shop, due to <2>.

(4) Because the shop tends to order more raw materials beforehand so that the commodity or raw material may not be in short supply on the shop side, or multiple persons (including the shop or supplier of commodity or raw material) in the supply chain are involved in forecasting the demand, this brings about a so-called bull whip effect (i.e., expanded information or forecasting is transmitted), causing a larger fluctuation in forecasting the demand and possibly resulting in excessive inventory.

The present invention has been achieved in the light of the above-mentioned problems, and it is an object of the invention to provide a commodity sales number forecasting system that can easily forecast the commodity sales number at each shop at high precision.

### SUMMARY OF THE INVENTION

In order to attain the above object, the inventors of this application adopted the following means, noting that the sales supporting activity at each shop or the purchasing trend of customers varies depending on the district, and the commodity sales number at the shop is greatly affected by the sales promotion through the advertising medium such as a spot CM of television.

According to one aspect of the invention, there is provided a commodity sales number forecasting system of the present invention for calculating the forecast sales number of a commodity at each shop for the commodity sold in a group of shops within a predetermined district, comprising a district sales number forecasting section for calculating the forecast sales number of a commodity within the predetermined district for each unit advertising district residing within the predetermined district and making the sales promotion activity at the same time employing the predetermined advertising medium, and a shop sales number forecasting section for calculating the forecast sales number at each shop by distributing the forecast sales number of the commodity in the unit advertising district to each shop within the unit advertising district.

With the above configuration, the unit advertising district where the sales promotion with the television CM is performed at the same time is set within the predetermined district, whereby all the shops within the predetermined district can be considered to be composed of shops in each unit advertising district. And for each aggregate of shops in this unit advertising district, the commodity sales number at the shop can be forecast in accordance with the district characteristics of the commodity purchasing trend or the presence or absence of the sales promotion activity. The term “commodity” also includes the commodity category consisting of a group of commodities of the same kind. Also, the term “advertising medium” includes the advertisement or inserted bill such as television CM, radio CM, newspaper, magazine, and discount tickets.

In this case, the district sales number forecasting section comprises a district ratio calculating portion for calculating a forecast sales number ratio of the forecast total sales number of the commodity at the shop within the unit advertising district to the forecast total sales number of the commodity in the group of shops within the predetermined district, and a district sales number calculating portion for calculating the forecast sales number of the commodity in the each unit advertising district from the forecast total sales number of the commodity at the shop within the predetermined district and the forecast sales number ratio. Thereby, the district ratio calculating portion can represent the purchasing trend in each unit advertising district as, for example, a ratio of the sales number in each unit advertising district to the total sales number in all the groups of shops.

In the case where the commodity consists of a plurality of kinds of unit goods, the district sales number calculating portion acquires a ratio of the commodity sales number of the plurality of kinds of unit goods to the forecast total number of visitors coming to the group of shops and calculates the forecast total sales number for each of the unit goods in the group of shops from the ratio and the forecast total number of visitors coming to the group of shops. In this manner, if the relation between the number of visitors and the sales number of each unit good is considered in each unit advertising district, the purchasing trend of customer or the preference can be correctly grasped.

If the district sales number forecasting portion calculates the forecast sales number of the commodity by referring to the past achievement of commodity sales when performing the sales promotion activity, forecasting the commodity sales number can be effected in each district by reflecting the past achievement of the sales promotion.

According to another aspect of the invention, there is provided a commodity sales number forecasting system comprising a district purchasing trend forecasting section for calculating a forecast index representing the customers' purchasing trend for each commodity in each unit advertising district performing the sales promotion activity at the same time by means of a predetermined advertising medium, a shop purchasing trend forecasting section for calculating a forecast ratio of the forecast index at a predetermined shop within the unit advertising district to the forecast index in the unit advertising district, and a shop commodity sales number calculating section for calculating the forecast sales number of the commodity at the predetermined shop on the basis of the forecast index, the forecast ratio and the forecast number of visitors coming to the predetermined shop.

That is, if the district purchasing trend forecasting section forecasts the index representing the customers' purchasing trend in each unit advertising district performing the sales promotion activity, and the shop purchasing trend forecasting section forecasts the ratio of the index representing the customers' purchasing trend at the predetermined shop to the forecast index within the unit advertising district, the commodity sales number at the predetermined shop can be directly forecast on the basis of the forecast results. In this case, the term ‘commodity’ also includes the commodity category consisting of a group of commodities of the same kind. Also, the term “advertising medium” includes the advertisement or inserted bill such as television CM, radio CM, newspaper, magazine, and discount tickets.

The “forecasting index” may be the commodity sales number for each commodity per unit visitor number, its inverse number, or the ratio of the commodity total sales number to the total number of visitors at each shop or in each unit advertising district.

In this case, if the shop purchasing trend forecasting section calculates the forecast ratio by comparing a ratio of the forecast commodity sales number in the unit advertising district calculated on the basis of the past achievement to the forecast number of visitors and a ratio of the forecast commodity sales number at the predetermined shop to the forecast number of visitors, the customers' purchasing trend or preference can be grasped as the numerical value independent of the commodity sales number.

Moreover, in this case, the shop purchasing trend forecasting section calculates the forecast index at the predetermined shop by referring to the past achievement of commodity sales when performing the sales promotion activity. Also, the forecast number of visitors coming to the predetermined shop can be calculated from the forecast sales amount and the forecast average visitor unit price at the predetermined shop that are determined on the basis of the past achievement.

According to a further aspect of the invention, there is provided a commodity sales number forecasting method of calculating a forecast commodity sales number in each unit district within a predetermined district where a plurality of unit districts are grouped by the use of a computer.

In this case, the commodity sales number forecasting method of the invention comprises a first step of calculating a forecast total commodity sales number within the predetermined district, a second step of calculating a forecast ratio of a forecast commodity sales number per unit visitor number in the unit district to a forecast commodity sales number per unit visitor number in the predetermined district, and a third step of calculating a forecast commodity sales number within the unit district using the forecast total commodity sales number and the forecast ratio. In this case, the term “commodity” also includes the commodity category consisting of a group of commodities of the same kind.

Also, the unit district may be the district performing the sales promotion activity at the same time employing a predetermined advertising medium.

In the case where the past data of the commodity sales number within the predetermined district is stored in a storage device, the first step may further comprise reading the data of the commodity sales number in the past term having the same property as the term to calculate the forecast commodity sales number in the unit district from the storage device and calculating the forecast total commodity sales number on the basis of the data.

Further, in the case where the past data of the forecast ratio is stored in a storage device, the second step may further comprise reading the data of the ratio of the commodity sales number per unit visitor number in the unit district to the commodity sales number per unit visitor number in the predetermined district in the past term having the same property as the term to calculate the forecast commodity sales number within the unit district and calculating the forecast ratio on the basis of the data.

According to another aspect of the invention, there is provided a computer program for calculating a forecast commodity sales number at a shop.

In this case, the computer program of the invention being executed on a computer comprises first means for calculating a forecast ratio of the commodity selling index at the shop to the commodity selling index within a unit district to which the shop belongs, second means for acquiring a forecast value of the commodity selling index within the unit district, and third means for calculating a forecast value of the commodity selling index at the shop from the forecast value of the commodity selling index acquired by the second means and the forecast ratio calculated by the first means and calculating the forecast commodity sales number at the shop on the basis of the forecast value.

Herein, the commodity selling index is the commodity sales number per unit visitor number, but may be its inverse value or the ratio of the commodity total sales number to the total number of visitors.

And if the computer program further comprises fourth means for displaying the commodity selling index calculated by the third means on a display screen, and fifth means for modifying the calculated result of the fourth means on the display screen, the forecast result of the commodity sales number can be modified at each shop.

Also, the first means may refer to an achievement ratio of the commodity selling index at the shop to the commodity selling index within the unit district to which the shop belongs for the predetermined commodity or its similar commodity from the past achievement data of commodity sales, when calculating the forecast ratio for a predetermined commodity.

Moreover, according to another aspect of the invention, there is provided a storage medium storing a computer program being executed on a computer in a readable format. In this case, the computer program stored in a storage device comprises means for calculating the sales number of a commodity to be sold within a predetermined district, means for calculating the sales number of the commodity to be sold in each of unit districts constituting the predetermined district from the commodity sales number, means for calculating the sales number of the commodity at each shop within the each unit district from the sales number of the commodity to be sold in each unit district, means for transmitting the calculated sales number of the commodity to be sold at each shop to each shop, and means for determining the sales number of the commodity to be sold at each shop on the basis of the returned result of the forecast sales number of the commodity that is sent back from each shop.

With the above configuration, the forecast sales number of commodity is determined at each shop by referring to the number of commodities to be soled that is transmitted to each shop, and the commodity or raw material can be forwarded on the basis of the number of sales determined at each shop. Accordingly, the final number of sales can be determined on the shop side.

### BRIEF DESCRIPTION OF THE DRAWINGS

FIG. 1 is a block diagram showing an overall configuration of a commodity sales number forecasting system according to one embodiment of the present invention;

FIG. 2 is a flowchart showing a procedure for a processing that is performed in the commodity sales number forecasting system as shown in FIG. 1;

FIG. 3 is a flowchart continued from FIG. 2;

FIG. 4 is a display screen example of visitor number ratio pattern in each TV area in a supply chain;

FIG. 5 is a display screen example showing a forecast value of a visitor number at each day nationwide;

FIG. 6 is a display screen example showing the forecast value of the visitor number in each TV area;

FIG. 7 is a display screen example showing the pattern of the ratio of the commodity sales number to the total commodity sales number;

FIG. 8 is a display screen example showing the pattern of the ratio of the sales number in each TV area to the total sales number for each commodity;

FIG. 9 is a display screen example for setting a sales plan that is displayed at a shop terminal of each shop;

FIG. 10 is a diagram typically showing a way of setting the past term to refer to the achievements in forecasting the commodity sales number in the forecast term of interest;

FIG. 11 is a diagram and a graph showing a way of calculating the ratio of the commodity selling index at each shop to the average commodity selling index (TV area achievement) in the TV area, which is employed in acquiring the commodity selling index at each shop; and

FIG. 12 is an example of an adjustment screen for the commodity selling index for each commodity that is displayed at the shop terminal of the shop.

### DESCRIPTION OF SYMBOLS

1 . . . Commodity sales number forecasting system

2 . . . Shop

2a . . . Shop terminal

3 . . . Server (computer)

4 . . . Internet

6 . . . TV (television) area sales number forecasting section (district sales number forecasting section)

7 . . . Shop sales number forecasting section

8 . . . Achievement reference term creating section

10 . . . Commodity sales number database (storage device)

26 . . . Shop purchasing trend forecasting portion

27 . . . TV area purchasing trend forecasting portion (district purchasing trend forecasting portion)

29 . . . Shop commodity sales calculating portion

36 . . . Image display portion

T . . . Commodity selling index

### DETAILED DESCRIPTION

The preferred embodiments of the present invention will be described below by reference to the accompanying drawings.

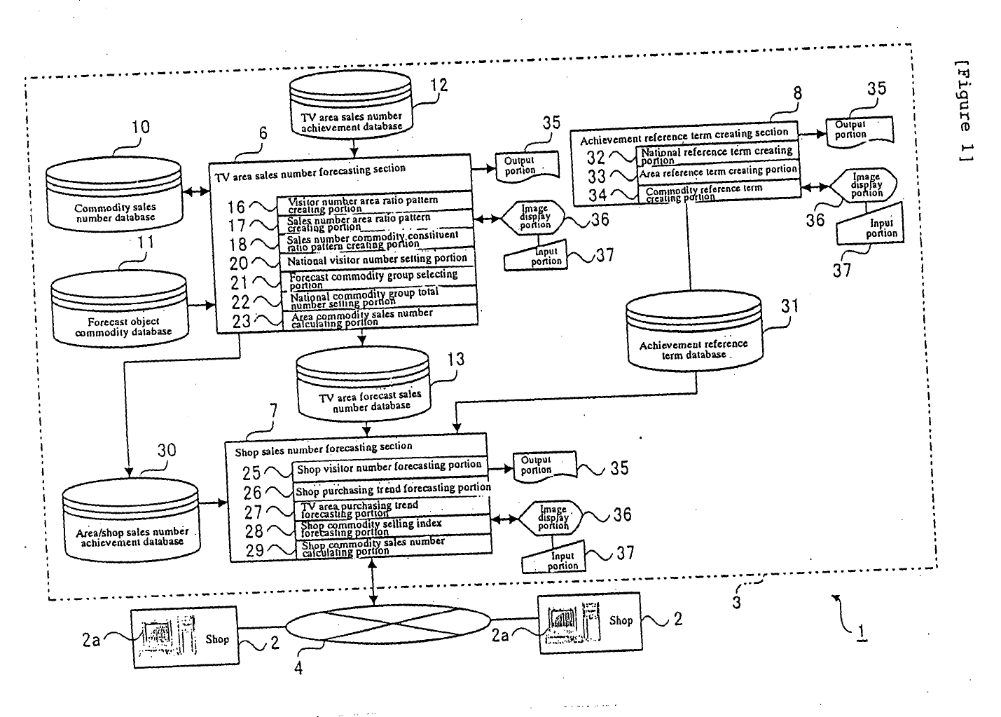

FIG. 1 is a block diagram for explaining an overall configuration of a commodity sales number forecasting system 1 according to one embodiment of the invention. In FIG. 1, the commodity sales number forecasting system 1 has a function of calculating the forecast commodity sales number of each commodity or each commodity category composed of commodities of the same kind at each shop 2 nationwide (in a predetermined district) in a supply chain, for example, and providing the calculated result to each shop 2. As shown in FIG. 1, the commodity sales number forecasting system 1 comprises a server (computer) 3 for forecasting the commodity sales number at each shop 2 and a shop terminal 2a at each shop 2 connected via a network such as the Internet 4 to the server 3.

As shown in FIG. 1, the server 3 comprises a TV (television) area sales number forecasting section (district sales number forecasting section) 6, a shop sales number forecasting section 7 and an achievement reference term creating section 8.

The TV area sales number forecasting section 6 is connected to a commodity sales number database (storage device) 10, a forecast object commodity database 11 and a TV area sales number achievement database 12. The TV area sales number forecasting section 6 calculates the forecast sales number of each commodity category or commodity in a predetermined term within each TV area (unit advertising district, unit district) that is a unit district for making the sales promotion (sales promotion activity) at the same time with a spot CM of the television broadcasting, employing the commodity sales number database 10, the forecast object commodity database 11 and the TV area sales number achievement database 12. This calculated result is input into the TV area forecast sales number database 13, and the shop sales number forecasting section 7 calculates the forecast sales number of each commodity (or commodity category) within a predetermined term at each shop 2 in each TV area, on the basis of the data output from the TV area forecast sales number database 13. Also, the TV area sales number forecasting section 6 has a visitor number area ratio pattern creating portion 16, a sales number area ratio pattern creating portion 17, a sales number commodity constituent ratio pattern creating portion 18, a national visitor number setting portion 20, a forecast commodity group selecting portion 21, a national commodity group total number setting portion 22, and an area commodity sales number calculating portion 23.

In particular, in them the visitor number area ratio pattern creating portion 16 creates a pattern of the ratio of the number of visitors coming to each TV area to the total number of visitors coming to the national Supply chain within a predetermined term, by referring to the past achievement of commodity sales and the number of visitors that are recorded in the TV area sales number forecasting section 6. Also, the sales number area ratio pattern creating portion 17 creates a pattern of the ratio of the number of sales in each TV area to the national number of sales for each commodity. The sales number commodity constituent ratio pattern creating portion 18 creates a pattern of the commodity selling index T for each commodity nationwide. This commodity selling index T is set with the number of sales for each commodity to the unit visitor number (e.g., 1000 visitors), for example. The meaning of the commodity selling index T will be described later.

The forecast commodity group selecting portion 21 selects a commodity or commodity category to forecast the commodity sales number from among some kinds of commodities or commodity categories recorded in the forecast object commodity database 11, and the national commodity group total number setting portion 22 calculates the total number of sales nationwide for each commodity or commodity category that is selected by the forecast commodity group selecting portion 21. Also, the area commodity sales calculating portion 23 calculates the commodity sales number for each commodity (or commodity category) in each TV area.

On one hand, the shop sales number forecasting section 7 has a shop visitor number forecasting portion 25, a shop purchasing trend forecasting portion 26, a TV area purchasing trend forecasting portion (district purchasing trend forecasting portion) 27, a shop commodity selling index forecasting portion 28, and a shop commodity sales number calculating portion 29. In particular, the shop visitor number forecasting portion 25 calculates the forecast number of visitors coming to each shop 2 within a predetermined term. Also, the shop purchasing trend forecasting portion 26 forecasts or calculates the purchasing trend of customers at each shop 2 in the TV area, employing the commodity selling index (forecast index) T, and the TV area purchasing trend forecasting portion 27 forecasts or calculates the purchasing trend of customers in each TV area as the commodity selling index T, on the basis of the data stored in the TV area forecast sales number database 13. Further, the shop commodity selling index forecasting portion 28 calculates the forecast value of the commodity selling index T at each shop 2 for each commodity on the basis of the calculated result of the shop purchasing trend forecasting portion 26 and the TV area purchasing trend forecasting portion 27, and the shop commodity sales number calculating portion 29 calculates the number of selling each commodity at the shop 2 on the basis of the calculated result of the shop commodity selling index forecasting portion 28.

The shop sales number forecasting portion 7 has the data output from an area/shop sales number achievement database 30. This area/shop sales number achievement database 30 stores the achievements of the commodity selling index T at each shop in each TV area, which is calculated employing the data aggregated by an aggregation system, not shown.

Further, the achievement reference term creating section 8 has a national reference term creating portion 32 for designating the past term for reference in forecasting the shop commodity sales number nationwide, in each TV area and at each shop 2, an area reference term creating portion 33 and a commodity reference term creating portion 34. Thereby, the achievement reference term creating section 8 designates the achievements of the past commodity sales number and so on to be referred to in forecasting the commodity sales number within a predetermined term at each shop 2 in the shop sales number forecasting section 7 in the nationwide level, TV area level and shop 2 level.

The achievement of the past commodity sales number designated in the achievement reference term creating section 8 is stored in the achievement reference term database 31, and the shop sales number forecasting section 7 calculates the forecast commodity sales number at each shop 2 by referring to the data stored in the achievement reference term database 31.

Also, the TV area sales number forecasting section 6, the shop sales number forecasting section 7 and the achievement reference term creating section 8 are connected to an output section 35, an image display section 36, and an input section 37.

The operation of the commodity sales number forecasting system 1 will be described below.

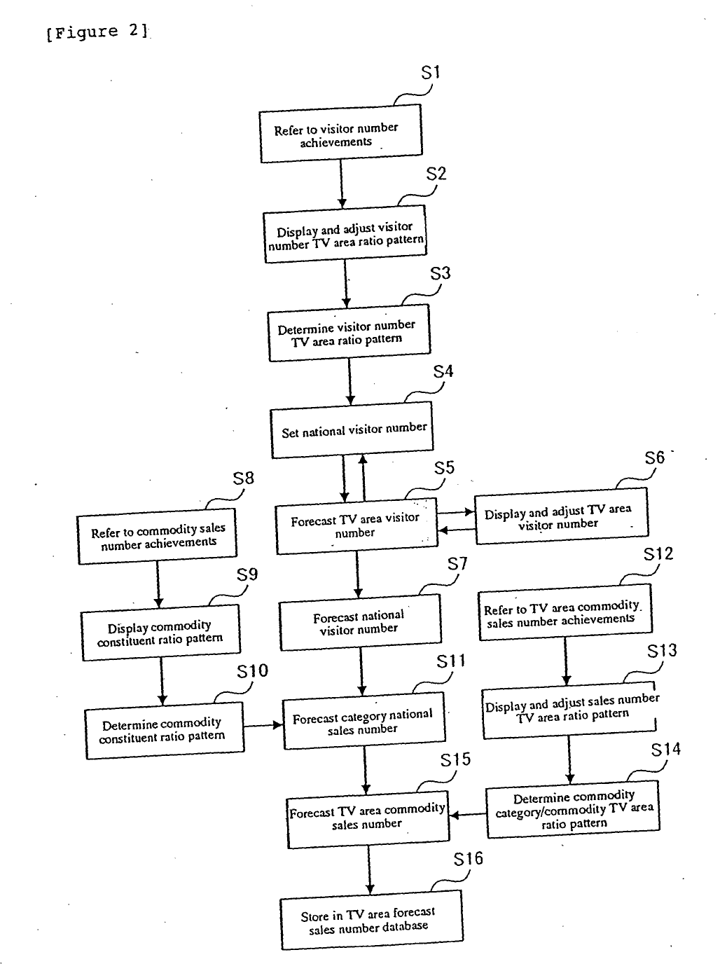

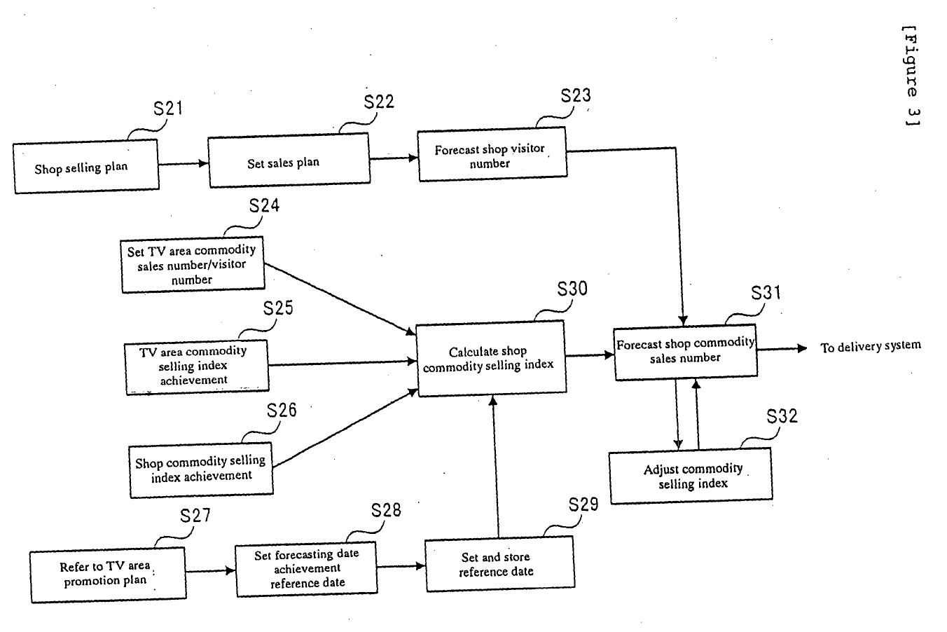

FIGS. 2 and 3 are flowcharts showing the procedures of processing in a computer program for operating the commodity sales number forecasting system 1. This computer program is stored in a storage device, not shown, within a server 3, and implements a function of calculating the forecast sales number daily and for each commodity at each shop 2 in the supply chain and transmitting it to each shop 2.

First of all, referring now to FIG. 2, an operation of calculating the commodity sales number in each TV area on the basis of the national commodity sales number in the commodity sales number forecasting system 1 will be firstly discussed.

For this purpose, the visitor number area ratio pattern creating portion 16 for the TV area sales number forecasting section 6 refers to the past achievement data of the number of visitors coming to all shops 2 in each TV area that is stored in the TV area sales number achievement database 12 (step S1), and calculates a pattern of the ratio of the number of visitors coming to shops in each TV area at the forecasting date of interest to the national number of visitors at the forecasting date of interest, employing that achievement data, and displays the ratio pattern on an image display portion 36 (step S2).

Herein, the TV area sales number achievement database 12 stores the past data for the number of visitors as a pattern, classified for each day property (e.g., summer vacation, holiday or weekday). At step S1, if the forecasting date of interest is a weekday in the summer vacation, for example, the visitor number area ratio pattern creating portion 16 refers to the data of “summer vacation weekday” pattern among the data stored in the TV area sales number achievement database 12, and displays it on the image display portion 36 at step S2.

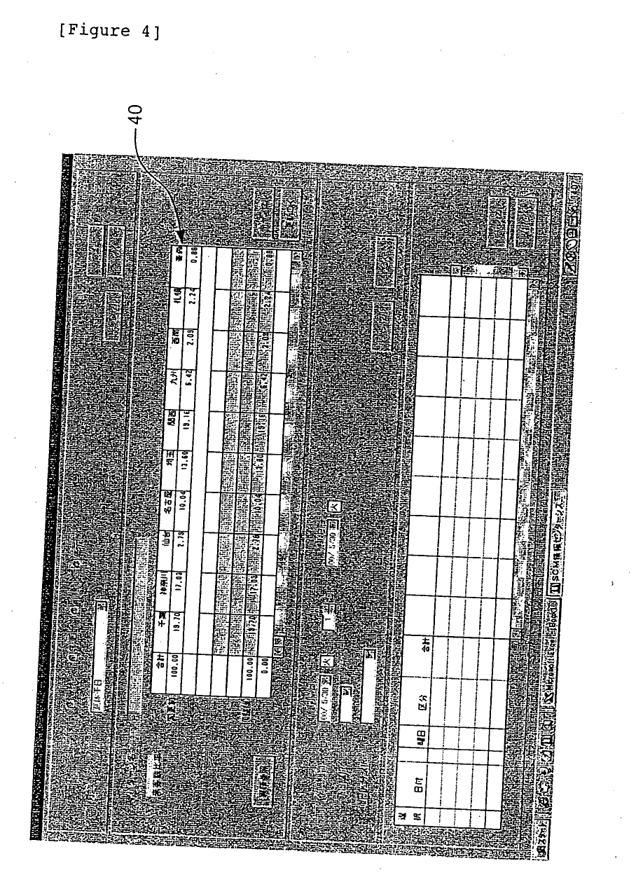

In this case, a table 40 appears on the screen of the image display portion 36, as shown in FIG. 4. In FIG. 4, the table 40 on the screen includes the ratio of the total number of visitors coming to the shop 2 in each TV area (Chiba, Kanagawa, Sendai, etc.) to the national number of visitors. The visitor number pattern for each TV area in the table 40 can be adjusted on the screen, as needed, and the visitor number area ratio pattern creating portion 16 determines the visitor number ratio pattern in each TV area on the basis of the pattern of the table 40 that has been adjusted (step S3). Also, the adjusted pattern is registered as a new pattern in the TV area sales number achievement database 12 and can be read out again.

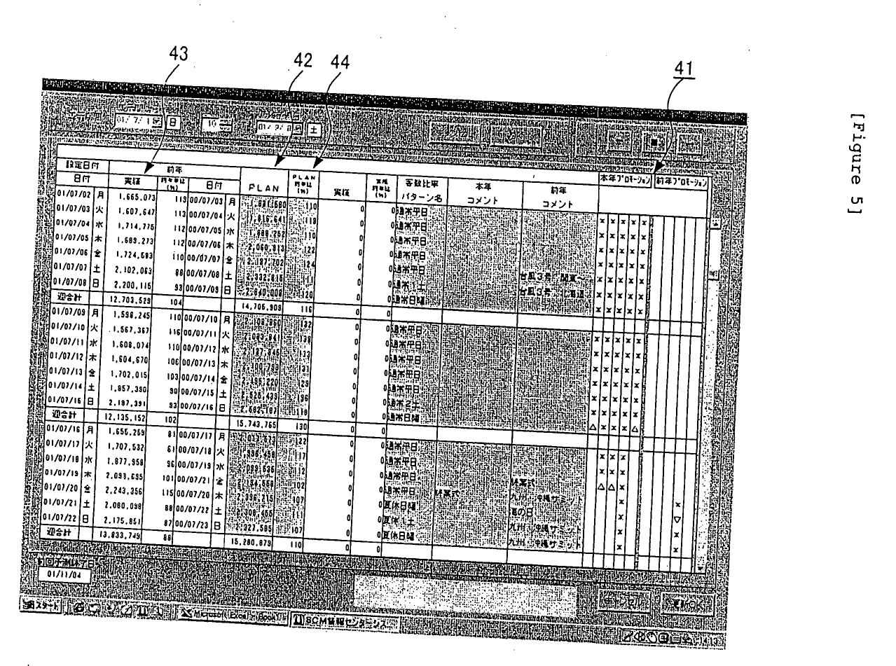

Then, the national visitor number setting portion 20 in the TV area sales number forecasting section 6 sets up the total number of visitors coming to all shops 2 nationwide by referring to the data stored in the TV area sales number achievement database 12 (step S4). At step S4, the national visitor number setting portion 20 displays a table 41 on the screen of the image display portion 36, as shown in FIG. 5. In the table 41, a forecast total visitor number (PLAN) 42 nationwide is calculated as the product between the total visitor number achievement 43 at the day in the past (the same day of the week in the same term of the previous year) having the same property as the forecasting day of interest and the visitor number ratio to the previous year (PLAN ratio to previous year (%)) 44 that is set on the basis of the business project or the like.

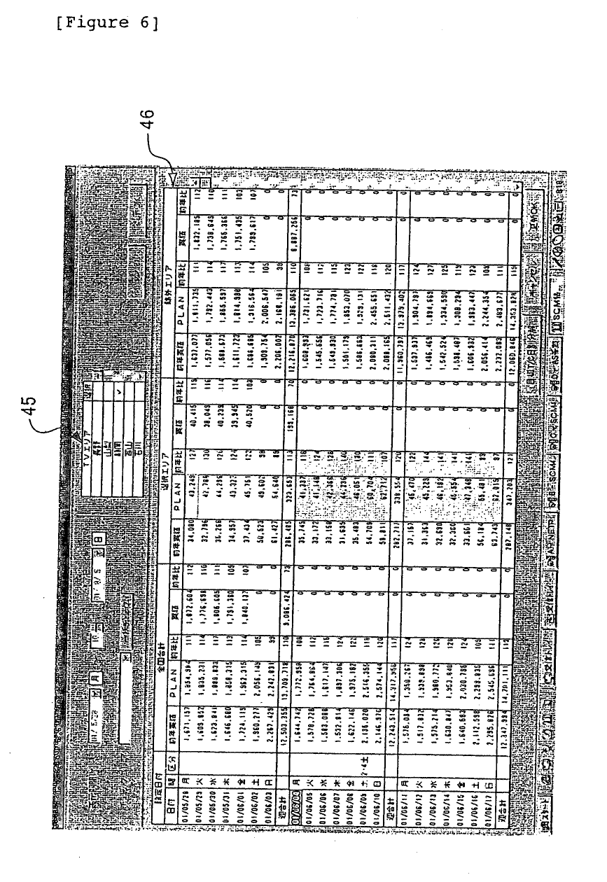

Then, the national visitor number setting portion 20 in the TV area sales number forecasting section 6 calculates the forecast number of visitors in each TV area from the national total number of visitors set at step S4, and the ratio of the visitor number in each TV area to the national total visitor number determined at step S3 (step S5). In this case, the national visitor number setting portion 20 displays the forecast value of the visitor number in the TV area selected in a selection column 45 as a table 46 on the image display portion 36 (step S6), with the visitor number in the selected TV area being adjustable on the screen, as shown in FIG. 6.

The data of the table 46 adjusted on the screen is fed back to step S5, where the forecast value of the visitor number in each TV area is reset, and on the basis of that, the forecast value of the national visitor number is reset as the total visitor number in each TV area after adjustment.

Also, the TV area sales number forecasting section 6 performs the processing from step S1 to step S7, as well as the processing from step S8 to step S14.

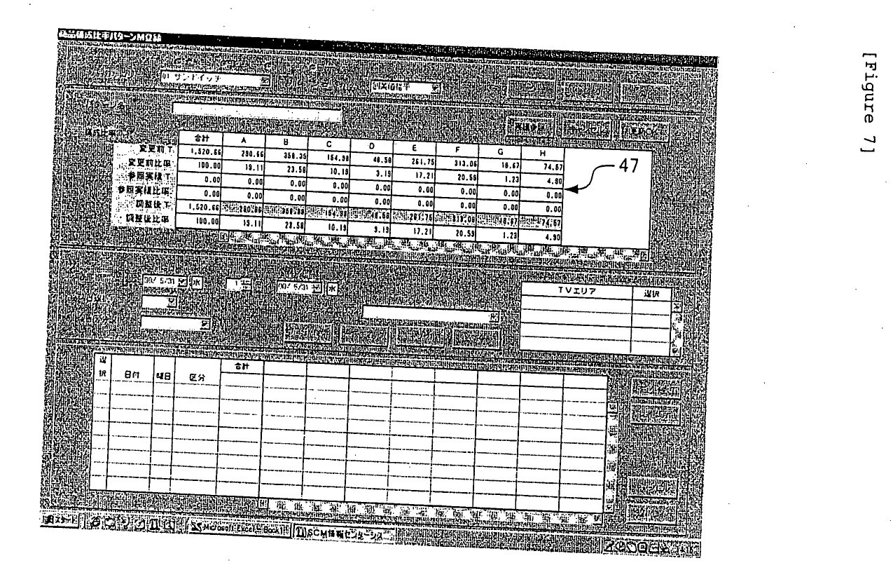

At step S8, the forecast commodity group selecting portion 21 in the TV area sales number forecasting section 6 designates the commodity to forecast the commodity sales number and the commodity category to which that commodity belongs by referring to the forecast object commodity database 11. Further, the sales number commodity constituent ratio pattern creating portion 18 in the TV area sales number forecasting section 6 refers to the achievement data regarding the commodity sales number nationwide that is stored in the commodity sales number database 10 (step S8), and displays the constituent ratio of the forecasting object commodity sales number to the commodity sales number in the commodity category to which the forecasting object commodity belongs (commodity sales number ratio) on the image display portion 36 (step S9). In this case, the constituent ratio (ratio before change) for each commodity category and each of the commodities A, B, C, . . . belonging to the commodity category is displayed in a table 47 on the screen, as shown in FIG. 7. This constituent ratio basically uses the pattern (reference achievement ratio) associated with the property of achievement reference date (summer vacation or within the campaign term for specific commodity) that is registered in the commodity sales number database 10 directly. That is, the constituent ratio (ratio before change) registered is employed without referring to the achievement as the already registered pattern again in FIG. 7.

Also, the constituent ratios (ratio before change, reference achievement ratio, ratio after adjustment) as cited in the table 47 are practically calculated from the commodity selling index T for the commodities A, B, C, . . . Herein, the commodity selling index T represents the number of selling each commodity A, B, C, . . . for every 1000 visitors, and serves to indicate how much the commodity is sold to the customers, namely, the purchasing trend of customer.

In this manner, since the commodity selling index T as the index indicating the sales number for each commodity A, B, C, . . . to 1000 visitors is shown along with the constituent ratio in the table 47, it is possible to grasp at a glance the purchasing trend of customer or how much the commodity is sold. This commodity selling index T is also employed when seeing the demand for each commodity at the shop 2 as will be described later.

The table 47 can be modified on the screen, in which the modified constituent ratio is represented as the ratio after adjustment in the table 47. And the sales number commodity constituent ratio pattern creating portion 18 determines the ratio after adjustment in the table 47 as the commodity constituent ratio pattern (step S10).

Further, the national commodity group total number setting portion 22 in the TV area sales number forecasting portion 6 calculates the commodity sales number nationwide for each commodity in every commodity category, on the basis of the national forecast visitor number obtained at step S7 and the commodity selling index T for each commodity obtained from the constituent ratio obtained at step S10 (step S11).

On the other hand, the sales number area ratio pattern creating portion 17 in the TV area sales number forecasting section 6 refers to the commodity sales number ratio in each TV area to the national commodity sales number on the basis of the data for the past achievement reference date having the same property as the forecasting date of interest among the data stored in the TV area sales number achievement database 12 (step S12), and displays the result on the image display portion 36 (step S13).

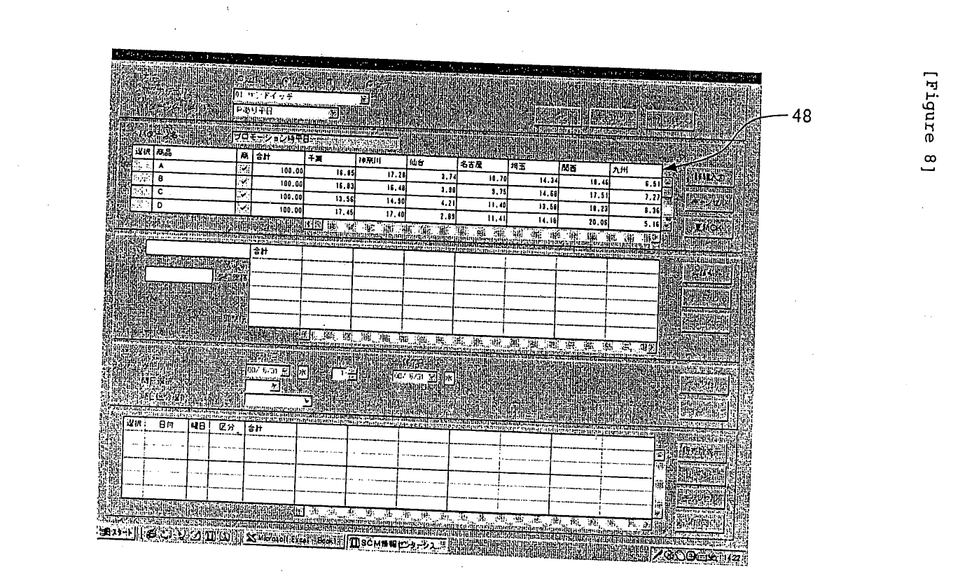

In this case, the table is displayed on the screen as shown in FIG. 8. That is, the ratio of commodity sales number in each TV area (Chiba, Kanagawa, Sendai, . . . ) (100 in total) for each of the commodities A, B, C, . . . in every commodity category is represented in a table 48. The ratio of commodity sales number in each TV area as represented herein employs the past achievement as the pattern associated with the property (e.g., summer vacation, weekday or holiday, within the campaign term for specific commodity) of achievement reference data, which is stored in the TV area sales number achievement database 12. Further, the TV area ratio pattern for each commodity category or commodity is determined by adjusting this table 48 on the screen (step S14).

Then, the TV area sales number forecasting section 6 forecasts or calculates the sales number for each commodity in each TV area from the forecast result of the commodity sales number nationwide for each commodity category at step S11 and the TV area ratio pattern for each commodity category or commodity determined at step S14 (step S15), and stores the calculated result in the TV area forecast sales number database 13 (step S16). The forecast result of the visitor number in each TV area that is forecast or calculated at step S5 is also stored in the TV area forecast sales number database 13.

In accordance with the above procedure, the forecast sales number for each commodity in each TV area is calculated. Referring now to FIG. 3, an operation will be described in which the commodity sales number forecasting system 1 performs calculation of the forecast sales number for each commodity at each shop 2 from the sales number for each commodity in each TV area.

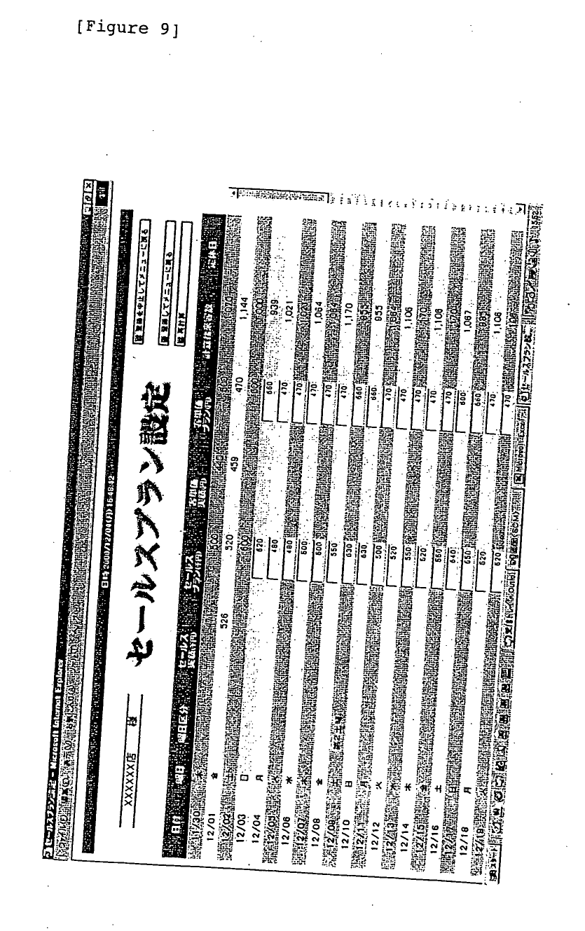

For this purpose, the shop sales number forecasting section 7 firstly refers to a shop selling plan that is input from the shop 2 side (step S21), sets up the shop selling plan at each shop 2, and transmits it from the server 3 to the shop terminal 2a at each shop 2. In this case, a table is displayed on the screen of the shop terminal 2a at the shop 2, as shown in FIG. 9. That is, at each shop 2, one inputs a sales plan (forecast sales amount) and a visitor unit price plan (forecast average visitor unit price) on the screen, on the basis of the selling plan at each shop 2 that is determined from the past achievement, and sends them back to the server 3, whereby the sales plan is set up (step S22), and the forecast visitor number at each shop 2 is calculated (step S23).

On one hand, the shop sales number forecasting section 7 sets up the forecast commodity sales number in each TV area and the forecast visitor number in each TV area by referring to the data stored in the TV area forecast sales number database 13 (step S24), refers to the past achievement data of the commodity selling index T in each TV area that resides in the area/shop sales number achievement database 30 (step S25), and further refers to the past achievement data of the commodity selling index T at each shop 2 (step S26).

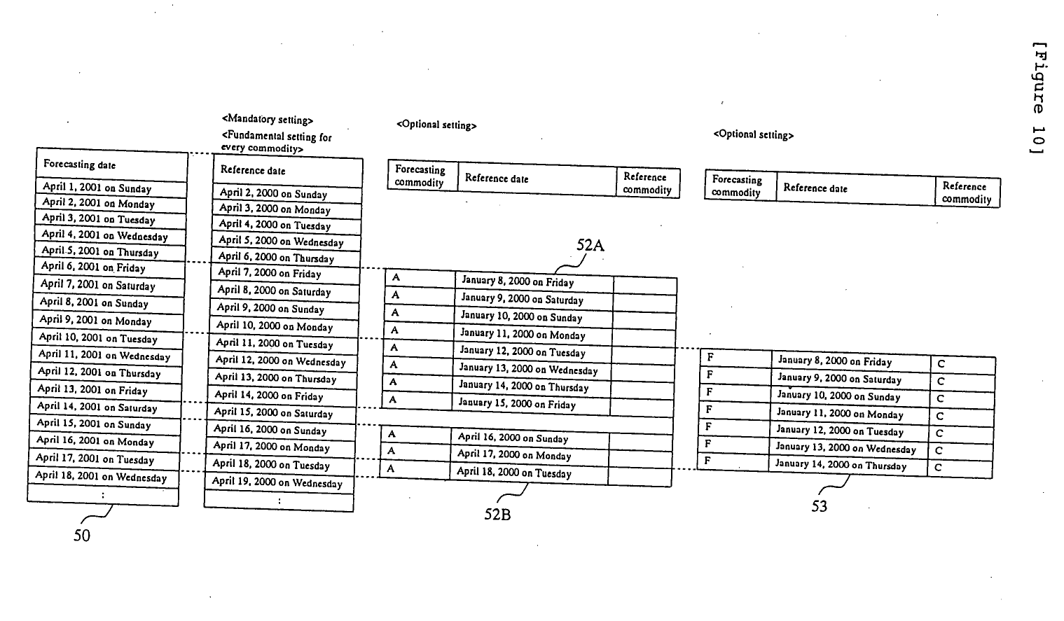

On the other hand, the achievement reference term creating section 8 refers to the data of the TV area promotion plan (step S27), and sets up the past date (reference date) to refer to the achievement at each shop 2 or in each TV area for each forecasting date of interest to forecast the commodity sales number (step S28). This is typically represented in FIG. 10. As represented in a table 50 of FIG. 10, if the forecasting date of interest spans from Apr. 1, 2001 (Sunday) to Apr. 18, 2001 (Wednesday), the national reference term creating portion 32 in the achievement reference term creating section 8 sets up the reference date as the term corresponding to the same days of the week in the same term of the previous year (Apr. 2, 2000 (Sunday) to April 19 (Wednesday)), as indicated in a table 51 of FIG. 10.

Further, the commodity reference term creating portion 34 in the achievement reference term creating section 8 sets Lip the reference date for each commodity by referring to the past sales promotion data. For example, for the commodity A, suppose that when the sales promotion is conducted at the forecasting date of interest from Apr. 6, 2001 to Apr. 13, 2001, the same sales promotion was conducted from Jan. 8, 2000 to Jan. 15, 2000 of the same day of the week. Then, the commodity reference term creating portion 34 sets up the reference term from Jan. 8, 2000 to Jan. 15, 2000 to forecast the commodity sales number for the commodity A from Apr. 6, 2001 to Apr. 13, 2001, as indicated in a table 52A. Moreover, when the sales promotion for the commodity A is conducted at the forecasting date of interest from Apr. 15, 2001 to Apr. 17, 2001, the same sales promotion was conducted from Apr. 16, 2000 to Apr. 18, 2000. Therefore, the commodity reference term creating portion 34 sets up the reference term from Apr. 16, 2000 to Apr. 18, 2000 to forecast the commodity sales number for the commodity A from Apr. 15, 2001 to Apr. 17, 2001, as indicated in a table 52B.

In this way, when the past reference date is determined, it is considered that a new commodity may have no past achievement. Accordingly, in this case, the past achievement of the similar commodity may be referred to. That is, to determine the reference date for a commodity F for which the sales promotion is conducted from Apr. 10, 2001 to Apr. 16, 2001 among the forecasting dates of interest, the sales achievement in the sales promotion for a commodity C similar to the commodity F, which is conducted from Jan. 8, 2000 to Jan. 14, 2000, is referred to, as indicated in a table 53.

To determine the reference date as shown in FIG. 10, the national reference term creating portion 32 firstly determines the reference date that is unique nationwide as the requisite setting. In the case where the sales promotion term is different for each commodity or in each district, the commodity reference term creating portion 34 arbitrarily sets up the reference date for each commodity, and the area reference term creating portion 33 arbitrarily sets Lip the reference date in each TV area. Also, the data regarding the set reference date is stored in the achievement reference term database 31 (step S29).

If the processing including step S23, step S24, step S25, step S26 and step S29 is ended, the shop sales number forecasting section 7 calculates the forecast value of the commodity selling index T for each commodity at each shop 2 in each TV area (step S30).

For this purpose, first of all, the TV area purchasing trend forecasting portion 27 calculates the forecast average value of the commodity selling index T in the TV area from the TV area commodity sales number set at step S24 and the forecast visitor number in this TV area. Moreover, on the basis of the result at steps S25 and S26, the shop purchasing trend forecasting portion 26 calculates the past achievement of the ratio of the commodity selling index T at each shop 2 to the commodity selling index T in each TV area as the forecast ratio at the past reference date set at step S29, and then the shop commodity selling index forecasting portion 28 calculates the commodity selling index T for each commodity at each shop 2 from the calculated forecast ratio and the forecast average value of the commodity selling index T in the TV area.

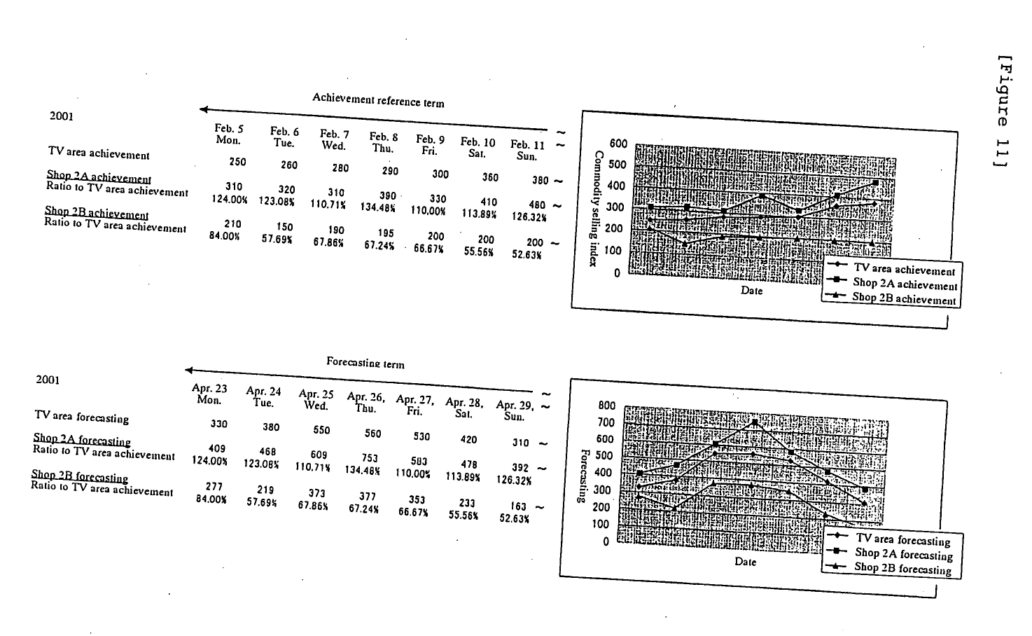

This procedure is shown in FIG. 11. At steps S25 and S26, the average value of the commodity selling index T in the TV area (TV area achievement) in the past achievement reference term and the commodity selling index T (shop 2A achievement and shop 2B achievement) at each shop 2 (e.g., shop 2A and shop 2B) in the TV area are obtained for the predetermined commodity, as shown in the upper stage and right column in FIG. 11. In this example, at the shop 2A, the commodity sales number per unit visitor number is greater than the TV area achievement for a predetermined commodity, while at the shop 2B, the commodity sales number per unit visitor number is smaller than the TV area achievement for the predetermined commodity. In this way, employing the commodity selling index T, it is possible to grasp the purchasing trend of customer for the predetermined commodity at the shop 2 in the TV area.

This is tabulated in the upper stage and left column of FIG. 11. Herein, the achievement reference term set at step S29 is from Feb. 5, 2001 to Feb. 11, 2001, and in the table, the TV area achievement in this term, and the achievement at shop 2A and the achievement at shop 2B are shown in contrast. In this table, by comparing the TV area achievement with the achievement at shop 2A and the achievement at shop 2B, the ratios of the achievement at shop 2A and the achievement at shop 2B to the TV area achievement can be obtained.

By the way, since the forecast average value of the commodity selling index T in the TV area can be calculated by the summation of the TV area forecast commodity sales number set at step S24 and the forecast visitor number in the TV area, as described above, the commodity selling index T at each shop 2 can be forecast by reflecting the past achievement of shop sales from this calculation result and the forecast ratio of the shop 2A achievement and the shop 2B achievement to the TV area achievement. That is, in the lower stage of FIG. 11, the forecast commodity selling index (TV area forecasting) in the TV area from Apr. 23, 2001 to Apr. 29, 2001 that is the forecasting term of interest can be obtained from the set result at step S24, and is multiplied by the ratio of the shop 2A achievement and the shop 2B achievement to the TV area achievement in the achievement reference term (Feb. 5, 2001 to Feb. 11, 2001) as tabulated in the upper stage and left column of FIG. 11 as the forecast ratio, whereby the forecast commodity selling index (shop A forecasting) at the shop 2A and the forecast commodity selling index (shop 2B forecasting) at the shop 2B can be calculated.

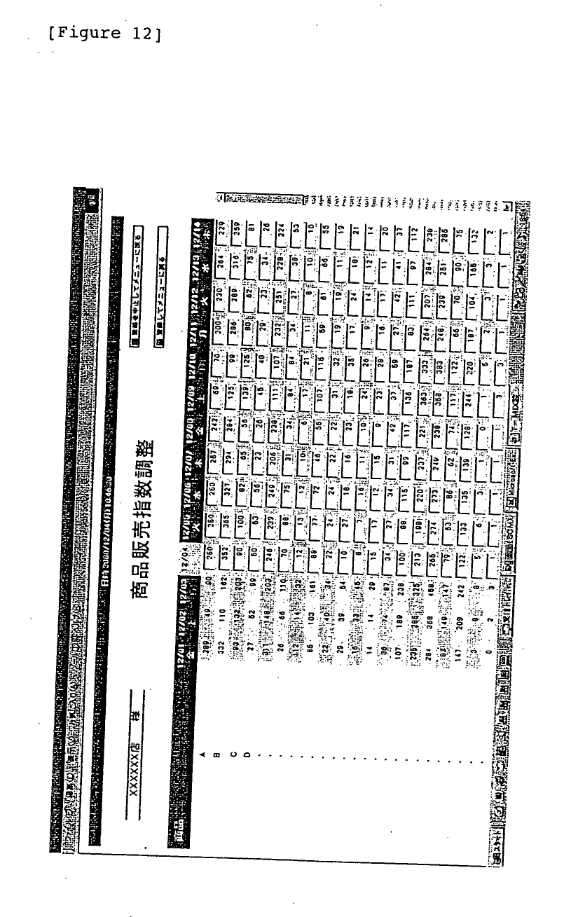

In the above way, the shop commodity selling index forecasting portion 28 provides the forecast value of the commodity selling index for each commodity at each shop 2. Moreover, the shop commodity sales number calculating portion 29 calculates the commodity sales number for each commodity at each shop 2 by multiplying this forecast value by the shop visitor number obtained at step S23 (step S31). In this case, the shop commodity sales number calculating portion 29 transmits the forecast commodity selling index T to each shop terminal 2a as a list of commodities A, B, C, . . . as shown in FIG. 12. At the shop 2, the commodity selling index T is adjusted on the screen through its own prospect of the sales, and sent back to the server 3. In the case where it is sent back, the shop commodity sales number calculating portion 29 recalculates the sales number of each commodity at each shop 2 on the basis of the adjusted commodity selling index T, determines the calculated result as the commodity sales number at each shop 2, and transmits it to a delivery system at each shop 2. And the delivery system forecasts or calculates the number of deliveries from the number of using the raw material at each shop 2, on the basis of the forecast commodity sales number, and delivers the commodity to each shop 2 on the basis of the forecast number of deliveries.

As described above, in this embodiment, the TV area sales number forecasting section 6 calculates the forecast commodity sales number in each TV area where the sales promotion with spot CM of television is performed, whereby the purchasing trend of customer in each district can be forecast, and the forecast commodity sales number at each shop 2 can be calculated by distributing the forecast commodity sales number in each TV area to each shop 2 on the basis of the purchasing trend of customer at each shop 2 within the TV area (the ratio of the commodity selling index T at each shop 2 to the average commodity selling index T in the TV areas). Thereby, the rational commodity sales number can be forecast in accordance with the differences in the content or frequency of television CM in each district that has significant effect on the sales of commodity. In addition, the commodity sales number can be forecast to cope with the difference in regional preference, whereby the commodity sales number can be forecast at high precision. Also, the number of deliveries can be forecast from the sales number at a higher precision.

Accordingly, in this embodiment, the operation load such as ordering at each shop 2 can be relieved, and the shortage or excessive inventory of commodity is eliminated, whereby the supply chain can supply the commodity more efficiently.

Particularly, the commodity sales number in each TV area is calculated by acquiring the sales number ratio pattern of predetermined commodity in each TV area in the sales number area ratio pattern creating portion 17, and multiplying it by the national sales number of predetermined commodity, whereby the characteristics of each TV area are more likely to be reflected on forecasting the commodity sales number. Further, the national sales number of predetermined commodity is calculated from the national visitor number and the commodity selling index T for each commodity, whereby the purchasing trend of customer for each commodity can be easily reflected on forecasting the commodity sales number. Moreover, in performing the sales promotion nationwide for the specific commodity, the sales promotion can be effectively attained by adjusting the purchasing trend of customer (commodity selling index T) to be set for the specific commodity.

Since the forecast sales number of commodity in each TV area or the national forecast visitor number, or the forecast commodity selling index T for each commodity are determined on the basis of the properties at the forecasting date of interest and by referring to the past achievement, the sales promotion or the difference in the number of visitors between weekday and holiday can be reflected effectively on forecasting the commodity sales number.

Further, since the commodity sales number at each shop 2 in each TV area is obtained by comparing the average value of the commodity selling index T in the TV area with the commodity selling index T at the shop 2 and calculating the forecast ratio, the purchasing trend of customer at each shop 2 in the TV area can be effectively reflected in forecasting the commodity sales number.

Moreover, the shop 2 can set up the number of visitors on the basis of the sales plan, and the commodity selling index T provided from the server 3 can be modified and reflected on forecasting the commodity sales number, whereby the commodity sales number can be determined through its own prospect in wide uses.

Though one embodiment of the present invention has been described above, this invention is not limited to the above embodiments, but may take another forms without departing from the spirit or scope of the invention.

For example, in the above embodiment, the commodity reference term creating portion 34 in the achievement reference term creating section 8 sets up the reference date for each commodity by referring to the past sales promotion data. However, besides that, the operator may set up the reference date manually by referring to the past sales promotion data.

Also, in the above embodiment, the commodity sales number at each shop 2 in each TV area is calculated by comparing the average value of the commodity selling index T in the TV area with the commodity selling index T at the shop 2. However, besides that, the statistical method involving the deviation value may be applied.

Also, in the above embodiment, the commodity sales number is forecast in each district where the sales promotion activity is made through the television. However, besides that, the commodity sales number may be forecast in each unit district where the sales promotion activity is made through other advertising media than the newspaper, magazine, discount ticket, and inserted bills.

Also, in the above embodiment, the commodity sales number at each shop 2 in the supply chain is forecast. However, the embodiment may be applied to forecasting the commodity sales number at other shops (e.g., independent shops) than the shop 2 in the supply chain.

Also, in the above embodiment, the commodity sales number forecasting system 1 is connected via the Internet 4 to each shop 2, but may be connected via other network such as the intranet or the private communication line to each shop 2, irrespective of whether the WWW system is employed.

In the above embodiment, a program for operating the commodity sales number forecasting system 1 may be stored in the storage medium or transmitted through the program transmission equipment.

That is, examples of the storage medium may include CD-ROM, DVD (Digital Versatile Disk), memory, and hard disk, which can store the program executed by the computer so that the computer can read the program.

Also, the program transmission equipment may comprise storage means such as CD-ROM, DVD, memory or hard disk that stores the program, and transmission means for transmitting the program read from the storage means via a network such as the Internet or LAN or the communication line such as telephone line to the computer that executes the program.

With this storage medium or program transmission equipment, the computer program is read into the computer system and executed to make the processing of forecasting the commodity sales number. In particular, the above-mentioned program transmission equipment is suitable in installing the program that performs the above processing.

The term “computer system” as used herein means the OS or hardware for the peripheral device, and the home page providing environment (or display environment) when the WWW system is employed.

Also, the above computer program may implement a part of the function in the above embodiment, or implement the function in combination with the program already stored in the computer system, and may be a so-called differential file (differential program).

Besides, the invention may be effected by selecting a part of the above embodiment or changed to other constitutions without departing from the spirit or scope of the invention.

As described above, with the invention, the commodity sales number at each shop can be easily forecast at high precision, so that the operation load such as ordering at each shop can be reduced, and the shortage or excessive inventory of the commodity is eliminated, making more efficient the supply of commodity in the supply chain.

1. A commodity sales number forecasting system for calculating a forecast sales number of a commodity at each shop for the commodity sold in a group of shops within a predetermined district, comprising:
a district sales number forecasting section configured to calculate the forecast sales number of a commodity within said predetermined district for each unit advertising district residing within said predetermined district performing sales promotion activity at the same time by use of a predetermined advertising medium; and
a shop sales number forecasting section configured to calculate the forecast sales number at each shop by distributing the forecast sales number of said commodity in said unit advertising district to each shop within said unit advertising district.

2. The commodity sales number forecasting system according to claim 1, wherein said district sales number forecasting section comprises:
a district ratio calculating portion configured to calculate a forecast sales number ratio of the forecast total sales number of said commodity at said shop within said unit advertising district to the forecast total sales number of said commodity in said group of shops within said predetermined district; and
a district sales number calculating portion configured to calculate the forecast sales number of said commodity in said each unit advertising district from the forecast total sales number of said commodity at the shop within said predetermined district and said forecast sales number ratio.

3. The commodity sales number forecasting system according to claim 2, wherein said commodity consists of a plurality of kinds of unit goods, said district sales number calculating portion acquires a ratio of the commodity sales number of said plurality of kinds of unit goods to a forecast total number of visitors coming to said group of shops and calculates the forecast total sales number for each of said unit goods in said group of shops from said ratio and said forecast total number of visitors.

4. The commodity sales number forecasting system according to claim 1, wherein said district sales number forecasting portion calculates the forecast sales number of said commodity by referring to past achievement of commodity sales when performing the sales promotion activity.

5. A commodity sales number forecasting system comprising:
a district purchasing trend forecasting section configured to calculate a forecast index representing a customers' purchasing trend for each commodity in each unit advertising district performing sales promotion activity at the same time by means of a predetermined advertising medium;
a shop purchasing trend forecasting section configured to calculate a forecast ratio of said forecast index at a predetermined shop within said unit advertising district to said forecast index in said unit advertising district; and
a shop commodity sales number calculating section configured to calculate the forecast sales number of said commodity at said predetermined shop on the basis of the said forecast index, said forecast ratio and a forecast number of visitors coming to said predetermined shop.

6. The commodity sales number forecasting system according to claim 5, wherein said shop purchasing trend forecasting section calculates said forecast ratio by comparing a ratio of said forecast commodity sales number in said unit advertising district calculated on the basis of the past achievement to the forecast number of visitors and a ratio of the forecast commodity sales number at said predetermined shop to the forecast number of visitors.

7. The commodity sales number forecasting system according to claim 5, wherein said shop purchasing trend forecasting section calculates said forecast index at said predetermined shop by referring to the past achievement of commodity sales when performing the sales promotion activity.

8. The commodity sales number forecasting system according to claim 5, wherein the forecast number of visitors coming to said predetermined shop is calculated from a forecast sales amount at said predetermined shop and a forecast average visitor unit price that are determined on the basis of the past achievement.

9. A commodity sales number forecasting method of calculating a forecast commodity sales number in each unit district within a predetermined district where a plurality of unit districts are grouped by the use of a computer, comprising:
calculating a forecast total commodity sales number within said predetermined district;
calculating a forecast ratio of a forecast commodity sales number per unit visitor number in said unit district to a forecast commodity sales number per unit visitor number in said predetermined district; and
calculating a forecast total commodity sales number within said unit district using said forecast total commodity sales number and said forecast ratio.

10. The commodity sales number forecasting method according to claim 9, wherein said unit district is set up as the district performing a sales promotion activity at the same time using a predetermined advertising medium.

11. The commodity sales number forecasting method according to claim 9, wherein the past data of the commodity sales number within the predetermined district is stored in a storage device, and said calculating a forecast total commodity sales number further comprises reading the data of the commodity sales number in the past term having the same property as the term to calculate the forecast commodity sales number in said unit district from said storage device and calculating said forecast total commodity sales number on the basis of said data.

12. The commodity sales number forecasting method according to claim 9, wherein the past data of said forecast ratio is stored in a storage device, and said calculating a forecast ratio further comprises reading the data of the ratio of the commodity sales number per unit visitor number in said unit district to the commodity sales number per unit visitor number in said predetermined district in the past term having the same property as the term to calculate the forecast commodity sales number within said unit district and calculating said forecast ratio on the basis of said data.

13. A computer program product for calculating a forecast commodity sales number at a shop, said computer program being executed on a computer comprising:
a first unit configured to calculate a forecast ratio of the commodity selling index at said shop to the commodity selling index within a unit district to which said shop belongs;
a second unit configured to acquire a forecast value of said commodity selling index within said unit district; and
a third unit configured to calculate a forecast value of said commodity selling index at said shop from the forecast value of said commodity selling index acquired by said second unit and said forecast ratio calculated by said first unit and calculating the forecast commodity sales number at said shop on the basis of said forecast value.

14. The computer program product according to claim 13, wherein said commodity selling index is a commodity sales number per unit visitor number.

15. The computer program product according to claim 13, further comprising a fourth unit configured to display said commodity selling index calculated by said third unit on a display screen, and a fifth unit configured to modify the calculated result of said fourth unit on said display screen.

16. The computer program product according to claim 13, wherein said first unit comprises calculating said forecast ratio for a predetermined commodity by referring to an achievement ratio of the commodity selling index at said shop to the commodity selling index within the unit district to which said shop belongs for the predetermined commodity or its similar commodity from the past achievement data of commodity sales.

17. A storage medium storing a computer program being executed on a computer in a readable format, said computer program comprising:
a unit configured to calculate a sales number of a commodity to be sold within a predetermined district;
a unit configured to calculate the sales number of the commodity to be sold in each of unit districts constituting said predetermined district from said commodity sales number,
a unit configured to calculate the sales number of the commodity to be sold at each shop within said each unit district from the sales number of the commodity to be sold in said each unit district;
a unit configured to transmit the calculated sales number of the commodity to be sold at each shop to said each shop; and
a unit configured to determine the sales number of the commodity to be sold at said each shop on the basis of the returned result of the forecast sales number of the commodity that is sent back from said each shop.
